(19) United States
(12) Patent Application Publication
(10) Pub. No.: US 2006/0191848 A1
(43) Pub. Date: Aug. 31, 2006

(54) Integrated separation of organic substances from an aqueous bio-process mixture

(76) Inventors: Nicole Ruffer, Aachen (DE); Christian Wandrey, Julich (DE); Ralf Takors, Merzenich (DE)

Correspondence Address: MORRISON & FOERSTER LLP, 12531 HIGH BLUFF DRIVE, SUITE 100, SAN DIEGO, CA, 92130-2040, US

(21) Appl. No.: 10/513,894

(22) PCT Filed: May 2, 2003
(86) PCT No.: PCT/DE03/01412

§ 371 Date: Jun. 15, 2005

(30) Foreign Application Priority Data
May 6, 2002 (DE) 102 20 235.4

(51) Int. Cl. C02F 9/00

(52) U.S. Cl. 210/631

(57) ABSTRACT

The present invention relates to a process for integrated removal of one or more organic substances present in an aqueous bioprocess mixture, which comprise at least one positively charged and/or chargeable nitrogen-containing group, by means of reactive extraction in at least one step, in which process at least one liquid-liquid centrifuge is used for said reactive extraction and said organic substances are re-extracted from the extractant into an aqueous phase. More specifically, the bioprocess mixture directed to the liquid-liquid centrifuges is rendered cell-free and protein-free, before being directed into the first centrifuge. Furthermore, the invention relates to such a process in which an aqueous bioprocess mixture is continuously removed from a bioreactor, led, with an extractant, into a liquid-liquid centrifuge, extracted by means of said extractant, with an organic phase being obtained which contains the substance to be extracted from the fermentation mixture. Said substance may be re-extracted in a cycle via a second liquid-liquid centrifuge, resulting subsequently in a concentrated aqueous solution of the extracted substance, and the organic phase being recycled into the first liquid-liquid centrifuge.

The present invention relates to a process for integrated removal from a bioreactor of one or more organic substances present in an aqueous bioprocess mixture, which comprise at least one positively charged and/or chargeable nitrogen-containing group, by means of reactive extraction in at least one step. Bioprocess mixture means, within the scope of the present patent application, any process mixture in which a biocatalytic reaction takes place, for example a fermentation with the aid of biomass or a chemical/enzymic process with the aid of dissolved, or carrier-bound, enzymes. Said processes may proceed either aerobically or anaerobically and may be operated as batch or (semi)continuous processes.

Numerous techniques for separating organic compounds from aqueous solutions (e.g. process mixtures) are known. These include, for example, fractionation via ion exchanger resins, chromatographic processes, adsorption, filtration, evaporation, reverse osmosis, electrodialysis, etc. Integration of such removal processes into bioprocesses such as fermentation processes has previously proved to be particularly difficult.

In this connection, the economic interest in obtaining amino acids has particularly increased in recent years, especially in view of the food and beverage industries. The desired amino acids are separated from bioprocess mixtures, for example, especially via ion exchangers or, for example, by means of reactive extraction. Until recently, however, these processes reached their limits in the purification of, in particular, culture broths. A disadvantage in treating culture liquids via ion exchangers was, for example, the requirement of an extensive pretreatment of the mixture to be purified.

It is moreover known that product formation in the fermentative production of L-phenylalanine in the fed-batch process is inhibited from an L-phenylalanine concentration of approx. 30 g/l upward. In order to prevent this inhibition, it is necessary to remove L-phenylalanine during the process. Such a process may be indicated as “in situ product recovery” (also: “ISPR”). The application of ISPR is described, for example, in publications by M. Gerigk et al., Bioprocess Biosyst. Eng. 25 (2002) 43-52, and by D. Maass et al., Bioprocess Biosyst. Eng. (gone to press).

WO/66253 describes a process for integrated reactive-extraction removal of nitrogen-containing organic substances present in an aqueous bioprocess mixture, using particular extractants which contain at least partially longer-chain organic compounds and at least one liquid cation exchanger as reactive carrier, and said extraction taking place in hollow fiber contactors via at least one porous membrane which is wettable by the aqueous mixture or the extractant. The function of the membrane here is to make possible a dispersion-free extraction process so that only mass of the nitrogen-containing organic substances is transferred via the membrane-stabilized phase interface by means of diffusion (maximally, within the limits of solubility of the organic phase and of the carrier). At the same time, the organic phase should in principle be prevented from entering the aqueous bioprocess mixture, since this could lead to the activity of the biocatalyst (and/or the microorganism) being reduced. Thus, there is no mixing of the two phases (organic extraction phase and aqueous bioprocess mixture) in principle in the membrane extraction system.

Choosing the reactive carrier systems according to WO/66253, nevertheless, makes very high demands on the biocompatibility of the components. Preference has been given to using the biocompatible substance system containing the solvent kerosene and the extractant (carrier) di(2-ethylhexyl)phosphoric acid (D2EHPA). The carrier D2EHPA was regenerated here in a second extraction stage using the extractant sulfuric acid. L-phenylalanine was concentrated in the sulfuric acid. This limits the possible system choices in general to combinations of kerosene and D2EHPA, respectively with dinonyl naphthalene sulfonic esters (DNNSE).

However, the handling of the membrane-assisted extraction system has proved to be complicated in practice, even on a pilot scale. It is possible to carry out only a limited scale-up when using hollow fiber contactors, due to, for example, the strong pressure dependence. As soon as pressure fluctuations occur, the phases can readily become unstable and this may cause a phase breakthrough and the formation of emulsions, with the process having to be stopped. Since furthermore membrane porosity always determines the maximum exchange surface, mass transport and extraction performance in membrane-assisted reactive extraction are quite limited.

It is therefore the object of the present invention to provide a process for integrated removal from a bioreactor of one or more organic substances present in an aqueous bioprocess mixture, which comprise at least one positively charged and/or chargeable nitrogen-containing group, by means of reactive extraction in at least one step, which process no longer has the abovementioned disadvantages.

This object is achieved by using at least one liquid-liquid centrifuge for said reactive extraction and by re-extracting the organic substances from the extractant into an aqueous phase.

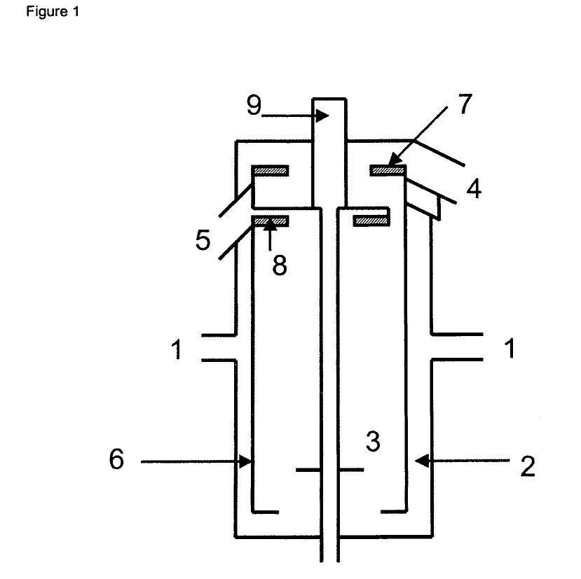

FIG. 1 depicts a diagrammatic illustration of a liquid-liquid centrifuge. The light (organic) and heavy (aqueous) phases are introduced separately into the centrifuge and mixed intensively in a mixing area with the aid of a rotor, and separation of light and heavy phases takes place thereafter in a separating area. The light and heavy phases are separately discharged, i.e. the heavy phase drains away along the rotor wall via the outer weir disk (whose size depends on the system); the light phase drains away inside via a solid weir. Weir disks, as may be used in liquid-liquid centrifuges, are metal disks which have a hole in the center—and which are generally adjustable or can be chosen, with respect to the size of the central hole—via whose size it is possible to regulate the draining away of the heavy phase.

In FIG. 1:
1 is, on one side, the bioprocess mixture supply, on the other side the extractant supply
2 is the mixing area and, respectively, extraction area
3 is the separating area
4 is the discharge of the heavy phase via the outer weir disk (7)
5 is the discharge of the light phase via a solid weir (8)
6 is a rotation cylinder
7 is the outer weir disk
8 is a solid weir
9 is a drive shaft.

The abovementioned disadvantages of the prior art are overcome in the inventive embodiment of the process as claimed in claim 1, with the dependent claims 2 to 14 further improving said process. The process of the invention has proved to achieve both a substantially higher performance (improved mass transport) and improved process operation. Moreover, results achieved on a limited scale have been shown to be readily transferable to a larger scale, for example to the 300 1 level. Preference, however, is given only to those solvents which, during shaking with an aqueous phase in a shaker flask, do not form any strong emulsions, since the action of the liquid-liquid centrifuge(s) would otherwise be impaired.

“At least one liquid-liquid centrifuge” means for the purpose of the present invention that further liquid-liquid centrifuges need not necessarily be used for further work-up of the bioprocess mixture. Thus, for example, the first extraction step (“forward extraction”) may be carried out in two (or even more) liquid-liquid centrifuges connected in parallel. This may take place continuously or semicontinuously. It is also possible, as will be described later in this description, to carry out the re-extraction using one or more liquid-liquid centrifuge(s). Thus, it would be possible to provide a second liquid-liquid centrifuge (or further liquid-liquid centrifuges in parallel) downstream (for re-extraction), as soon as, after a certain time, the organic phase in the first liquid-liquid centrifuge has been well loaded. However, re-extraction may also be carried out using other techniques, for example membrane-assisted as in WO/66253.

According to the invention, materials for extraction (i.e. the bioprocess mixture, for example a fermentation broth, and, respectively, the extractant, for example D2EHPA in kerosene) are supplied in the forward extraction to the centrifuge (see FIG. 1) (1). Mixing of the two phases, i.e. the extraction, takes place on the outside of the rotor (2). Inside, the phases are separated in the centrifugal field (3)+(6). The heavy phase leaves the centrifuge on the outside (4), the light phase on the inside (5). Optimal separation of the two phases may be ensured, for example, via the size of the weir disk(s) chosen (7)+(8).

The residence time in the centrifuge, i.e. the contact time of the phases, may also be varied by altering the volume stream. Moreover, changing the number of revolutions influences the phase interface, as also the strength of the centrifugal field may alter separation of the aqueous and organic phases. The process of the invention can be easily controlled by varying the number of revolutions and/or volume streams. Both are simple optimization parameters which may be chosen freely.

In addition, model type-dependent modifications may be introduced to the centrifuges, rotors, etc. in order to further optimize the process. In the case of the rotors, for example, there is a choice of “low-shear” or “high-shear” rotors. It is also possible, depending on the model type, to use other separators such as, for example, disk separators, either with disks spinning in opposite directions to one another or with static disks.

In a preferred embodiment of the invention, the bioprocess mixture directed to the (first) liquid-liquid centrifuge is rendered cell-free, before being directed into said centrifuge. In a further preferred embodiment of the invention, the bioprocess mixture directed to the (first) liquid-liquid centrifuge is additionally also rendered protein-free. This results in a cell-free and biocatalyst-free bioprocess solution. Preference is given to the aqueous bioprocess mixture being a fermentation mixture. Depending on the type of reaction, the fermentations may proceed aerobically or anaerobically and may be operated as a batch, semicontinuous or continuous process.

The principle of the invention of liquid-liquid centrifugation may be applied both to the forward extraction (from the medium present in the bioreactor) and in the re-extraction in which the substances to be obtained are taken up again into an aqueous phase, preferably in a concentrated form.

More specifically, a process is used in which the first liquid-liquid centrifuge is followed downstream by a further extraction step which comprises re-extracting the extracted substance from the first extraction step into an aqueous phase. Preference is given to the further extraction step also being carried out in a liquid-liquid centrifuge.

Re-extraction in a liquid-liquid centrifuge comprises delivering the organic phase loaded in the forward extraction (extractant, for example D2EHPA in kerosene, with extracted substances taken up therein), on the one hand, and the aqueous phase which has been adjusted to a low pH, for example with sulfuric acid, on the other hand, separately to a liquid-liquid centrifuge for the back extraction. For illustration purposes, reference should be made here again to FIG. 1. The organic phase and the aqueous phase are supplied at (1). Mixing of the two phases, i.e. re-extraction, takes place again on the outside of the rotor (2). In the re-extraction too, the phases are separated inside, owing to the centrifugal force (3)+(6), after which separation the heavy phase leaves the centrifuge on the outside (4) and the light phase leaves on the inside (5). In the re-extraction too, optimal separation of the two phases is ensured, for example, via the size of the weir disk(s) chosen, (7)+(8). As already mentioned above, the re-extraction may also be carried out, however, using other techniques.

In the process of the invention, the extraction performance in the first liquid-liquid centrifuge preferably corresponds at least to the rate of production in the bioprocess. Extraction performance in one extraction step (or even in an entire process, if the total process of integrated removal is referred to as an extraction process) means the extractive removal of one component per hour in said extraction step (or in said entire process)—from the bioprocess mixture. The total amount discharged may be indicated in mol. Rate of production means the amount, produced biocatalytically in the bioprocess per hour, of that component (in mol) which can be discharged extractively from the bioprocess mixture in said extraction step (or in said entire process).

The extractants used for integrated extraction of organic substances which contain at least one positively charged and/or chargeable nitrogen-containing group from a bioprocess mixture are preferably the same extractants as in WO/66253, i.e. preference is given to using for extraction in the first liquid-liquid centrifuge an extractant containing at least partially longer-chain organic compounds and at least one liquid cation exchanger. The at least partially longer-chain organic compounds act as solvent in the processes of the invention. The liquid cation exchanger acts as a carrier.

The longer-chain organic compounds used are preferably those compounds which are miscible with water only with difficulty or are soluble in water only with difficulty and are liquid at temperatures between 10 and 60° C., preferably between 20 and 40° C. Possible compounds here are branched, unbranched, saturated, unsaturated or partially aromatic organic compounds. Examples of longer-chain organic compounds which may be used according to the invention are alkanes, alkenes or fatty esters or mixtures of two or more of these compounds. Longer-chain organic compounds used here are in particular alkanes, alkenes or fatty esters having from 6 to 20 carbon atoms, preferably having from 12 to 18 carbon atoms.

Examples of alkanes which may be used are hexane, cyclohexane, decane, ethyldecane, dodecane or mixtures thereof. Particular preference is given kerosene. Alkenes which may be used are, for example, hexene, nonene, decene, dodecene or mixtures thereof. Fatty esters which may be used are in particular alkyl stearates having alkyl groups with more than 2 carbon atoms. Examples of fatty esters are ethyl stearate, butyl stearate, isopropyl stearate, ethyl palmitate or butyl linoleate. Particular preference is given to using kerosene or butyl stearate. Two or more of said organic compounds may also be used in the form of mixtures.

The liquid cation exchangers used are in particular esters of inorganic acids and organic radicals which are preferably branched. The inorganic acids preferably include phosphoric acid, phosphorous acid, sulfuric acid and sulfurous acid. More specifically, preferred liquid cation exchangers used are esters of phosphoric acid, phosphorous acid, sulfuric acid or sulphurous acid. Very particular preference is given to esters of phosophoric acid. The organic radicals used according to the invention are preferably branched and/or unbranched alkyl or alkenyl groups having at least 4 carbon atoms, preferably from 4 to 20 carbon atoms. The preferred liquid cation exchangers include di(2-ethylhexyl)phosphate, mono(2-ethylhexyl)phosphate, dinonyl naphthalene sulfonate or mixtures thereof. Most preferred liquid cation exchangers are di(2-ethylhexyl)phosphate, mono(2-ethylhexyl)phosphate, dinonyl naphthalene sulfonate or mixtures thereof. Most preferred according to the invention is the mixture of di(2-ethylhexyl)phosphate and mono(2-ethylhexyl)phosphate.

The amount of liquid cation exchanger in the first liquid-liquid centrifuge is generally from 2 to 25% by weight, preferably from 5 to 20% by weight, particularly preferably from 8 to 15% by weight, based on the amount of longer-chain organic compounds.

Examples of extractable substances include L-amino acids but it is also possible to remove D-amino acids in an integrated process according to the invention. In principle, both natural and non-natural amino acids are extractable. Possible amino acids are all D- and L-forms of essential amino acids. Examples of extractable amino acids are L-phenylalanine, D-phenylalanine, L-tryptophan, D-tryptophan, L-tyrosine, D-tyrosine, D-p-hydroxyphenylglycine, D-phenylglycine, dihydroxyphenylalanine. It is also possible to remove aromatic β-amino acids such as, for example, β-phenylalanine or β-tyrosine. The process of the invention may furthermore be used for extracting lactams. These include, inter alia, also β-lactams, for example caprolactam.

It is furthermore possible, according to the invention, also to extract peptides, but in particular di- or oligopeptides. These include, for example, L-aspartyl-L-phenylalanine as a precursor molecule for preparing aspartame. Also extractable are amino alcohols, for example 1S,2R-cis-(-)-aminoindanol and (amino)cyclitols. The extraction of the invention may moreover be applied to obtaining amines or amides.

The bioprocess mixture preferably contains organic substances selected from the group consisting of aliphatic and/or aromatic amino acids and/or lactams, salts, derivatives or di- or oligopeptides thereof or mixtures of these compounds which are extracted from the bioprocess mixture according to the invention.

According to the invention, the extractant may contain, in addition to the compounds mentioned, also other substances. These include also extractants known according to the prior art.

The process of the invention for integrated removal from a bioreactor of one or more organic substances present in an aqueous bioprocess mixture, which comprise at least one positively charged and/or chargeable nitrogen-containing group, by means of reactive extraction in at least one step is preferably operated continuously. In this preferred continuous embodiment

(a) an aqueous bioprocess mixture is continuously removed from the bioreactor, and

(b) led with an extractant into a liquid-liquid centrifuge, and

(c) extracted there by means of an extractant, with an organic phase being obtained which contains the substance to be extracted from the bioprocess mixture, and

(d) the aqueous retentate obtained is recycled into the bioreactor.

It is, of course, also possible to use in step (a), instead of the aqueous bioprocess mixture, any other reaction mixture produced in a (bio)reactor, which contains organic substances with at least one positively charged and/or chargeable nitrogen-containing group.

Examples of such substances have already been indicated above.

A very particularly preferred field of use of the process of the invention is the extraction from fermentation solutions, wastewaters and/or aqueous mixtures of chemical synthesis and/or degradation processes. More specifically, the process of the invention can be integrated in fermentation processes. Said fermentation processes may proceed aerobically or anaerobically and may be operated as batch, semicontinuous or continuous processes.

In this connection, the organic substances are, according to the invention, preferably re-extracted from the extractant into an aqueous phase. For this purpose, in particular, the organic phase of (c) is contacted in a further process step (e) with an aqueous acceptor phase and re-extracted in a closed circulation.

Suitable acceptor phases for discharging the carriers are in general all suitable proton donors, for example H⁺ from sulfuric acid. It is of course also possible to use in step (e), instead of sulfuric acid, any other strong acid. Other examples are ammonium sulfate, hydrochloric acid and phosphoric acid.

Contact with the aqueous acceptor phase takes place preferably in a liquid-liquid centrifuge and the diluted organic phase resulting therefrom is recycled continuously or semicontinuously into the centrifuge of step (b).

Even more preference is given to rendering cell-free the aqueous bioprocess mixture in stage (a), in a further step [a1], via a bypass with ultrafiltration module (cut-off at approximately 500 kDa), with the cell material being recycled into the bioreactor. A cell-permeate is obtained which is led to step (b).

In a further preferred process [a2], the cell-free permeate is rendered protein-free via a membrane cassette in the nano range (cut-off at approximately 10 kDa to 50 kDa), with the protein-containing portion of the cell-free permeate being recycled into the bioreactor, the cell-free and protein-free permeate obtained being led, with the extractant, to step (b) into the first liquid-liquid centrifuge.

The best yields of the process of the invention are obtained when the aqueous retentate is completely recycled into the bioreactor in stages (d) and (e). Overall, the aqueous retentate is then completely recycled into the bioreactor.

A particular advantage of the process of the invention is the fact that re-extraction is carried out with simultaneous concentration of the organic substances. Most preferably, the process of the invention is carried out continuously and simultaneously with a reaction proceeding in the bioreactor, with the extraction performance of the entire process being at least equal to the rate of production in the bioreactor. The extraction is preferably carried out from fermentation solutions.

However, the inventive process for integrated removal of substances from a bioprocess mixture may also be used, in principle, for integrated removal of substances from processes other than biocatalytic processes. In this case, reference is better made to a container in which a reaction proceeds from which a substance is desired to be removed continuously, rather than to a bioreactor (or fermentation reactor, or fermenter). However, a container of this kind is generally usually referred to as bioreactor.

Compared to the work with hollow fiber contactors, handling and scale-up are easier when using liquid-liquid centrifuges. After the start, the system runs stably, even if at times no light or heavy phase is supplied. Phase instability, owing to pressure differences, is thus not a problem. The phase interface and thus the mass transfer in this system are likewise increased.

This kind of integrated use of liquid-liquid centrifuges in a fermentation process during fermentation is novel, although liquid-liquid centrifuges have been known for a long time and can be purchased commercially, for example from CINC Deutschland GmbH, Brakel, Germany. CINC Deutschland is a subsidiary of Costner Industries Nevada Corporation, USA.

It should be noted that, although Likidis and Schugerl (Biotech. & Bioeng., vol. 30, pages 1032-1040, 1987; DE-A-3729338) have successfully used liquid-liquid centrifuges in the work-up of bioprocess mixtures after fermentation had been completed, in particular for obtaining penicillin, they always used toxic extractants and the biocatalysts used never came into contact with the extractants used in the extraction. Moreover, the substances extracted by Likidis and Schugerl were always removed from the medium by way of reaction with a carboxyl group. There is no indication in said publications that it would be possible to use liquid-liquid centrifuges also in an integrated procedure in fermentation processes. Extractions via various liquid membranes (liquid-emulsion membranes) are described in Thien, M. P. et al. (Biotechnol Bioeng. 1998, 32: 604-615), but may not be used under conditions with high shear stress, as with the use of centrifuges.

Surprisingly, it was found that very high yields of extracted substances are possible in the inventive process for reactive extraction integrated in fermentation processes with the use of at least one liquid-liquid centrifuge. Thus it has proved possible to obtain in the acceptor phase L-phenylalanine at concentrations in the range of up to approximately 80 g/l, and possibly still even higher concentrations are made possible.

In principle, the current invention enables thus also smaller amounts of carrier to be worked with than have been customary previously in the prior art.

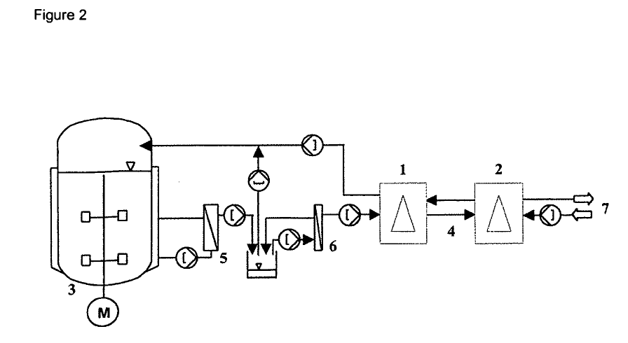

The application of the process of the invention on the basis of an integrated fermentation process, for example for producing L-phenylalanine, will be illustrated in more detail below with the aid of FIG. 2:

FIG. 2 depicts a bioreactor (3) in which fermentative production of L-phenylalanine is carried out. This bioreactor (fermenter) is connected to a bypass with ultrafiltration module (UF I; 500 kDa) (5) through which the fermentation broth is pumped during the process in order to obtain cell-free permeate. In the process, said cell-free permeate is pumped into a storage vessel. From there, the cell-free permeate is circulated through a second ultrafiltration unit (UF II; 10 kDa) (6) in order to remove the proteins present in the permeate. The cell- and protein-free permeate thus obtained is pumped into a first liquid-liquid centrifuge (1) to extract the L-phenylalanine with the extractant, for example D2EHPA in kerosene. After extraction and phase separation, the raffinate is recycled into the fermenter. The organic phase (e.g. D2EHPA in kerosene) is circulated (4), and re-extraction, for example with sulfuric acid, takes place in the second liquid-liquid centrifuge (2). As a result, L-phenylalanine is concentrated in the aqueous phase. Extractant and/or proton donor may be supplied via (7) (or the loaded extractant containing concentrated extracted substance is discharged to recover said substance).

In FIG. 2, to put it differently:
1 is a first liquid-liquid centrifuge, with supply of the cell- and protein-free bioprocess mixture and of the extractant, or with discharge of the diluted bioprocess mixture and of the loaded extractant,
2 is a second liquid-liquid centrifuge, with supply of the loaded extractant and metering of proton donor from (7), or with discharge of the extractant to be loaded further to (1), or of the loaded extractant to recovery of the concentrated substance,
3 is the bioreactor,
4 is the circulation of the organic phase,
5 is an ultrafiltration module (UF I; cutoff at approximately 500 kDa),
6 is an ultrafiltration unit (UF II; 10 kDa; nano range, cutoff at approximately 10 kDa),
7 is the supply and discharge of extractant and/or proton donor,
M is a drive.

The invention will now explained in more detail on the basis of an example and of some comparative examples.

In the present example, work was carried out in an arrangement according to FIG. 2, with a bioreactor with a fermentation volume of 10 I (batch) and a bypass volume of approximately 1.2 I. Ultrafiltration module I (Schleicher und Schüll GmbH, Dassel, Germany; a hollow fiber filtration module) had a cutoff at 500 kDa. Ultrafiltration module II (likewise from Schleicher und Schüll GmbH, Dassel, Germany) had a cutoff of 10 kDa and consisted of five cassette modules. The extractant used for the forward extraction was D2EHPA (Merck) in kerosene (Fluka).

### EXAMPLE I

### Fermentative Preparation of L-phenylalanine

A fermentation with integrated extraction was carried out in the bioreactor (fermenter). Fermentation was started as a batch process. During the growth phase of the cells (of an L-phenylalanine-producing tyrosine-auxotrophic E. coli strain), production was induced after approx. 6 hours and the ammonia, glucose and tyrosine feed was started. The growth phase was stopped by limiting tyrosine for the E. coli after a total time of approx. 14 hours. After a total time of approximately 22 hours, about 15 g/l L-phenylalanine, i.e. a significant L-phenylalanine concentration, were present in the medium, with a good rate of formation. At this point in time, the process for obtaining cell-and protein-free permeate was started, followed by the extraction.

The extraction parameters of the liquid-liquid centrifuges, which were used for the fed-batch fermentation process and the integrated reactive extraction, were as follows:
first liquid-liquid centrifuge:
   heavy phase: fermentation broth with L-phenylalanine, volume flow: 2.4 l/h
   light phase: 10% strength solution of D2EHPA in kerosene, volume flow: 3.36 l/h
second liquid-liquid centrifuge
   heavy phase: 1M sulfuric acid,
   volume flow: 1.5 l/h
   light phase: 10% strength solution of D2EHPA in kerosene, volume flow: 3.36 l/h

The extraction was carried out for approx. 18 hours, i.e. until process hour 40, when the process was stopped. The extraction system proved stable with supply of protein-free medium. An adverse effect of the extraction, for example by introduction of kerosene or D2EHPA, on the fermentation process could not be detected.

In this example I, the L-phenylalanine concentration in the bioreactor increased until reactive extraction was started and furthermore remained constant at approximately 12-15 g/l during integrated extraction. The L-phenylalanine concentration at the outlet of the first centrifuge was always at approximately 7 g/l after extraction. The L-phenylalanine content in the sulfuric acid increased almost linearly from 0 to approximately 59 g/l between hours 22 and 40, i.e. after an extraction time of 18 hours. Thus a great increase in the L-phenylalanine concentration could be achieved.

The L-phenylalanine concentration theoretically achieved in this example may be calculated by adding up the L-phenylalanine concentrations in the bioreactor and in the aqueous sulfuric acid, based on the actual fermentation volume. Thus, a theoretical final concentration of L-phenylalanine of 52 g/l would have been achieved in this example.

### COMPARATIVE EXAMPLE A

The theoretical final L-phenylalanine concentration in a fermentation carried out comparatively as in example I under otherwise identical fermentation conditions (amount and activity of E. coli cells, etc.), but without integrated extraction, i.e. only one bioreactor and no extraction apparatus were used, was 31 g/l.

### COMPARATIVE EXAMPLE B

The theoretical final L-phenylalanine concentration in another fermentation carried out comparatively under otherwise identical fermentation conditions (amount and activity of E. coli cells, etc.), but with integrated extraction via hollow fiber contactors with membranes according to WO/66253, was approximately 30 g/l.

Thus, a much higher final L-phenylalanine concentration was achieved in the integrated process of the invention, using liquid-liquid centrifuges, than in the comparative examples.

Moreover, it has proved possible in the integrated process of the invention, using liquid-liquid centrifuges, to maintain L-phenylalanine production over a relatively long period of time, of at least 50 hours of fermentation, without inhibition occurring in the bioreactor.

The rate of L-phenylalanine product formation is distinctly above 0.03 g/(g*h) until the end of the 50-hour period. In contrast, the comparable rate of product formation in a standard fermentation without integrated removal of L-phenylalanine via liquid-liquid centrifuges, decreases down to zero, with a process time of 36 hours, and down to 0.02 g/(g*h) in a standard fermentation with integrated removal of L-phenylalanine via membrane-assisted extraction according to WO/66253, with a process time of 36 hours.

In example I according to the inventive process of integrated product removal via liquid-liquid centrifuges, the rate of product formation increased as a function of fermentation time and reached a maximum shortly after the extraction of L-phenylalanine had started. The rate of extraction also reached a maximum at approximately the same time. The rate of extraction remained at a level of between 1.1 g/(l*h) and 1.7 g/l*h) in the further course until extraction is switched off. The volumetric product formation behaved comparably and decreased only slightly after the fermentation had been switched off. Due to the approximately equal rates of production and extraction, a strong accumulation of L-phenylalanine in the bioreactor was surprisingly substantially suppressed. The concentration of L-phenylalanine in the bioreactor remained essentially constant, in the range from 12 to 15 g/l.

The integral product substrate yield in example I was calculated as being 24% at the end of the fermentation, i.e. an improvement by 6.5% was found in comparison with a fermentation without reactive extraction using liquid-liquid centrifuges (with a yield of 17.5%). With membrane-assisted reactive extraction, in contrast, an improvement by only 5% was found in comparison with a fermentation without membrane-assisted reactive extraction, with a yield of 15.3%.

1. A process for integrated removal from a bioreactor of one or more organic substances present in an aqueous bioprocess mixture, which one or more organic substances comprise at least one positively charged and/or chargeable nitrogen-containing group, by means of reactive extraction in at least one step, comprising
extracting one or more organic substances from said mixture using at least one liquid-liquid centrifuge to effect said reactive extraction; and
re-extracting said organic substances from an extractant, wherein said extractant contains at least partially longer-chain organic compounds and at least one liquid cation exchanger, into an aqueous phase.

2. The process as claimed in claim 1, wherein the bioprocess mixture directed to the first liquid-liquid centrifuge is rendered cell-free, before said extracting step.

3. The process as claimed in claim 2, wherein the bioprocess mixture is rendered protein-free before said extracting step.

4. The process as claimed in claim 1, wherein the aqueous bioprocess mixture is a fermentation mixture.

5. The process as claimed in claim 1, further comprising after the extracting step
re-extracting the extracted substance from the extracting step into an aqueous phase.

6. The process as claimed in claim 5, wherein the further re-extracting step is carried out in a second liquid-liquid centrifuge.

7. The process as claimed in claim 1, wherein the extraction performance in the first liquid-liquid centrifuge corresponds at least to the rate of production in the bioprocess.

8. The process as claimed in claim 1, wherein said longer-chain organic compounds are alkanes, alkenes or fatty esters having from 6 to 20 carbon atoms.

9. The process as claimed in claim 8, wherein the liquid cation exchanger contained in the first liquid-liquid centrifuge is an ester of an inorganic acid and an organic radical.

10. The process as claimed in claim 9, wherein the liquid cation exchanger is an ester of phosphoric acid, phosphorous acid, sulfuric acid or sulfurous acid.

11. The process as claimed in claim 9, wherein the liquid cation exchanger contained in the first liquid-liquid centrifuge is di(2-ethylhexyl)phosphate, mono(2-ethylhexyl)phosphate, dinonyl naphthalene sulfonate or mixtures thereof.

12. The process as claimed in claim 9, wherein the first liquid-liquid centrifuge contains from 2 to 25% by weight, of liquid cation exchanger, based on the amount of longer-chain organic compounds.

13. The process as claimed in claim 1, wherein organic substances contain an aliphatic and/or aromatic amino acid and/or lactam, a salt, a derivative or a di- or oligopeptide thereof or mixtures of these compounds.

14. A process for integrated removal from a bioreactor of one or more organic substances present in an aqueous bioprocess mixture, which comprise at least one positively charged and/or chargeable nitrogen-containing group, by means of reactive extraction in at least one step, comprising
a. continuously removing an aqueous bioprocess mixture from the bioreactor, and
b. leading said mixture with an extractant, which contains at least partially longer chain organic compounds and at least one liquid cation exchanger, into a liquid-liquid centrifuge,
c. extracting by means of said extractant, and obtaining an organic phase which contains the substance to be extracted from the bioprocess mixture, and
d. recycling the resultant aqueous retentate into the bioreactor.

15. The process as claimed in claim 14, further comprising
e. contacting the organic phase of c. with an aqueous acceptor phase and re-extracting in a closed circulation.

16. The process as claimed in claim 15, wherein contact with the aqueous acceptor phase takes place in a liquid-liquid centrifuge, and in that a diluted organic phase resulting therefrom is recycled continuously or semicontinuously into the centrifuge of step b.

17. The process as claimed in claim 14, wherein stage a. further comprises
a1) rendering the aqueous bioprocess mixture cell-free via a bypass with ultrafiltration module (cut-off at approximately 500 kDa),
recycling the cell material into the bioreactor, and
obtaining a cell-free permeate which is led to step b.

18. The process as claimed in claim 17, further comprising
a2) rendering the cell-free permeate protein-free via a membrane cassette in the nano range (cut-off at approximately 10 kDa to 50 kDa),
recycling the protein-containing portion of the cell-free permeate into the bioreactor, and
obtaining the cell-free and protein-free permeate which is led, with the extractant, to step b. into the first liquid-liquid centrifuge.

19. The process as claimed in claim 14, wherein in stages c. and d. the aqueous retentate is completely recycled into the bioreactor.

20. The process as claimed in claim 14, wherein the re-extracting step is carried out with simultaneous concentration of the organic substances.

21. The process as claimed in claim 14, wherein the extraction step is carried out continuously and simultaneously with a reaction proceeding in the bioreactor, with the extraction performance being at least equal to the rate of production in the bioreactor.

22. The process as claimed in claims 14, wherein the bioprocess mixture is a fermentation solution.

23. The process of claim 8 wherein the alkanes, alkenes, or fatty esters have from 12 to 18 carbon atoms.

24. The process as claimed in claim 9 wherein the ester is branched.

25. The process as claimed in claim 12 wherein the first liquid-liquid centrifuge contains 5 to 20% by weight of liquid cation exchanger.

26. The process as claimed in claim 12 wherein the first liquid-liquid centrifuge contains 8 to 15% by weight of liquid cation exchanger.
